(19) United States
(12) Patent Application Publication
(10) Pub. No.: US 2021/0073841 A1
(43) Pub. Date: Mar. 11, 2021

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventor: Shigeru Namiki, Wako-shi (JP)

(21) Appl. No.: 17/012,085

(22) Filed: Sep. 4, 2020

(30) Foreign Application Priority Data
Sep. 10, 2019 (JP) 2019-164688

(51) Int. Cl. G06Q 30/02; G06Q 30/06; G06Q 10/06; B60L 53/66; H02J 7/00

(52) U.S. Cl. CPC G06Q 30/0207; G06Q 30/0645; H02J 7/0047; B60L 53/665; G06Q 10/06311

(57) ABSTRACT

An information processing device includes a first acquirer configured to acquire a usage request regarding use of a charging facility for charging a battery mounted in a vehicle from a terminal device of a first user, a second acquirer configured to acquire permission information indicating permission of the usage request from a terminal device of a second user who is authorized to use the charging facility in a time zone associated with a desired time zone included in the usage request, and a processor configured to give the second user a reward for the permission on the basis of the usage request acquired by the first acquirer and the permission information acquired by the second acquirer.

### CROSS-REFERENCE TO RELATED APPLICATION

Priority is claimed on Japanese Patent Application No. 2019-164688, filed Sep. 10, 2019, the content of which is incorporated herein by reference.

### BACKGROUND

### Field of the Invention

The present invention relates to an information processing device, an information processing method, and a storage medium.

### Description of Related Art

A system in which a charging schedule of an electric car is deleted if its charging time zone overlaps a designated time zone for a user, a charging schedule in which an available time zone before the designated time zone is set as a charging time zone is registered if the predicted amount of charging before the designated time zone is less than the amount of charging required for use in the designated time zone, and a rental schedule in which the designated time zone is set as a rental time zone is registered if the predicted amount of charging is equal to or greater than the required amount of charging is disclosed in the related art (Japanese Unexamined Patent Application, First Publication Nos. 2013-15933 and 2015-230719).

The above system does not take into consideration processing when a charging facility is in use.

### SUMMARY

The present invention has been made in view of such circumstances and it is an object of the present invention to provide an information processing device, an information processing method, and a storage medium that can encourage flexible use of charging facilities.

The information processing device, the information processing method, and the storage medium according to the present invention have the following configurations.

(1) An information processing device according to a first aspect of the present invention includes a first acquirer configured to acquire a usage request regarding use of a charging facility for charging a battery mounted in a vehicle from a terminal device of a first user, a second acquirer configured to acquire permission information indicating permission of the usage request from a terminal device of a second user who is authorized to use the charging facility in a time zone associated with a desired time zone included in the usage request, and a processor configured to give the second user a reward for the permission on the basis of the usage request acquired by the first acquirer and the permission information acquired by the second acquirer.

(2) As a second aspect of the present invention in accordance with the first aspect, the processor is configured to acquire a reward from the first user and give the acquired reward to the second user.

(3) As a third aspect of the present invention in accordance with the second aspect, the processor is configured to set the reward acquired from the first user and the reward given to the second user to be equivalent.

(4) As an fourth aspect of the present invention in accordance with the first aspect to the third aspect, the processor is configured to determine a reward to be given to the second user on the basis of a length of a time zone during which the first user desires to use the charging facility defined in the usage request.

(5) As a fifth aspect of the present invention in accordance with the first aspect to the fourth, the permission information includes a condition for the permission, and the processor is configured to give a reward to the second user on the basis of the condition for the permission.

(6) As a sixth aspect of the present invention in accordance with the first aspect to the fifth, the condition for the permission is one or both of the usage time of the charging facility and the reward.

(7) As a seventh aspect of the present invention in accordance with the first aspect to the sixth, further including a proposer configured to, when the first acquirer has acquired the usage request, acquire a charging facility to be recommended to the second user on the basis of the usage request and transmit information on the acquired charging facility to the terminal device of the second user.

(8) As an eight aspect of the present invention in accordance with the seventh aspect, the charging facility to be recommended to the second user is a charging facility which the second user is able to move to within a predetermined time from a current location of the second user or which is present within a predetermined distance from the current location and which the second user is able to use after arriving at the charging facility.

(9) An information processing method according to an ninth aspect of the present invention includes an information processing method causing a computer perform: acquiring a usage request regarding use of a charging facility for charging a battery mounted in a vehicle from a terminal device of a first user, acquiring permission information indicating permission of the usage request from a terminal device of a second user who is authorized to use the charging facility in a time zone associated with a desired time zone included in the usage request, and giving the second user a reward for the permission on the basis of the usage request and the permission information.

(10) A storage medium according to a tenth aspect of the present invention stores a program causing a computer to acquire a usage request regarding use of a charging facility for charging a battery mounted in a vehicle from a terminal device of a first user, acquire permission information indicating permission of the usage request from a terminal device of a second user who is authorized to use the charging facility in a time zone associated with a desired time zone included in the usage request, and give the second user a reward for the permission on the basis of the usage request and the permission information.

According to the first aspect to tenth, the information processing device gives the second user a reward for the permission on the basis of the usage request and the permission information, thereby encouraging flexible use of the charging facility.

According to the fourth aspect, the information processing device gives the second user a reward according to the usage time of the first user, thereby improving satisfaction of the second user.

According to the fifth aspect or the sixth aspect, the information processing device gives the second user a reward according to the condition for permission by the second user, thereby further improving satisfaction of the second user. According to the seventh aspect or the eighth aspect, the information processing device recommends a charging facility to the second user, thereby allowing the second user to make a better choice for him or her as to whether to permit the first user to use the charging facility.

### BRIEF DESCRIPTION OF THE DRAWINGS

FIG. 1 is a diagram showing an example of a configuration of an information processing system 1 including an information processing device.

FIG. 2 is a diagram showing an example of a functional configuration of the information processing device.

FIG. 3 is a diagram showing an example of content of a reservation schedule.

FIG. 4 is a diagram showing an example of a functional configuration of a charging facility.

FIG. 5 is a sequence diagram showing an example of a flow of processing executed by charging applications and the information processing device.

FIG. 6 is a diagram showing an example of an image displayed on a display.

FIG. 7 is a diagram showing an example of an image.

FIG. 8 is a diagram showing an example of an image.

FIG. 9 is a diagram showing an example of content of an image.

FIG. 10 is a diagram showing an example of content of reward information.

FIG. 11 is a diagram showing an example of a functional configuration of an information processing device.

FIG. 12 is a diagram showing an example of an image.

FIG. 13 is a diagram showing an example of an image.

FIG. 14 is a diagram showing an example of a hardware configuration of an information processing device according to an embodiment.

### DETAILED DESCRIPTION

Hereinafter, embodiments of an information processing device, an information processing method, and a storage medium of the present invention will be described with reference to the drawings. As used throughout this disclosure, the singular forms “a,” “an,” and “the” include plural reference unless the context clearly dictates otherwise.

### First Embodiment

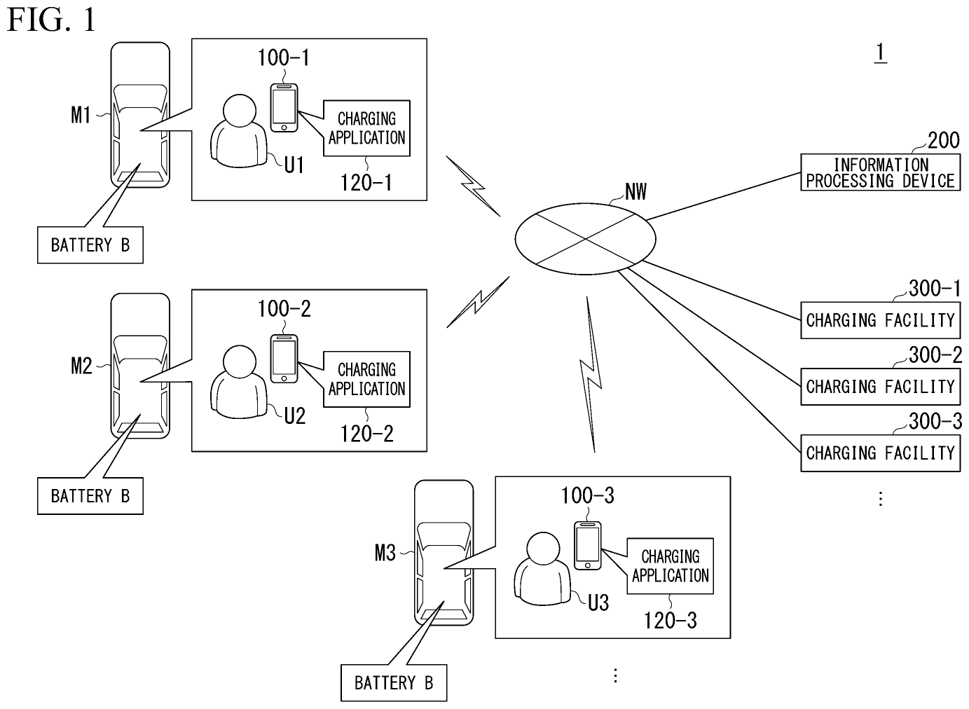

FIG. 1 is a diagram showing an example of a configuration of an information processing system 1 including an information processing device 200. The information processing system 1 includes, for example, one or more terminal devices 100 (100-1 to 100-3 in FIG. 1), an information processing device 200, and charging facilities 300. The terminal devices 100, the information processing device 200, and the charging facilities 300 communicate with each other, for example, via a network NW. The network NW includes, for example, a cellular network, a Wi-Fi network, Bluetooth (registered trademark), the Internet, a wide area network (WAN), a LAN, a public line, a provider device, a dedicated line, or a wireless base station.

The terminal devices 100 are, for example, terminal devices held by users U (U1 to U3 in FIG. 1). The users U are users who use vehicles M (M1 to M3 in FIG. 1). Each vehicle M is, for example, a vehicle in which a battery B is mounted. The vehicle M includes an electric motor that is driven by electric power supplied by the battery B. The vehicle M may be, for example, a hybrid vehicle or a fuel cell vehicle that travels by combined driving of an internal combustion engine such as a diesel engine or a gasoline engine with the battery B. The vehicle M may be an automobile, a saddle type vehicle (an electric two-wheeled vehicle), an electric three-wheeled vehicle, an electric four-wheeled vehicle, an electric kick scooter, a robot, or the like. In the present embodiment, each vehicle M is an electric vehicle.

The vehicle M may be, for example, an automated driving vehicle that includes a recognizer for recognizing the surroundings outside the vehicle and is automatically driven based on the recognition result of the recognizer.

The vehicle M includes a communicator, a controller, and the like. The communicator is a communication interface that communicates with the information processing device 200. The controller acquires the state of charge of the battery, the position of the vehicle M, and the like and transmits the acquired information to the information processing device 200.

### [Terminal Device]

The terminal devices 100 are terminal devices held by users who use a charging support service. The charging support service is a service that supports reservations for use of the charging facilities 300. The terminal devices 100 are terminal devices that can be carried by users such as smartphones, tablets, or personal computers. Each terminal device 100 is realized, for example, by a processor such as a central processing unit (CPU) executing a program (software) stored in a storage device. Some or all functions executed by the terminal device 100 may be realized by hardware such as a large scale integration (LSI), an application specific integrated circuit (ASIC), or a field-programmable gate array (FPGA) or may be realized by hardware and software in cooperation.

An application, a browser, or the like for using the charging support service provided by the information processing system 1 is activated on the terminal device 100 to support the service described below. In the following description, it is assumed that terminal devices 100 are a smartphone and applications (charging applications 120) are used in processes relating to the charging support service. Each charging application 120 communicates with the information processing device 200 according to an operation performed by a user U to transmit a request of the user U to the information processing device 200 or provide a push notification based on information received from the information processing device 200.

### [Information Processing Device]

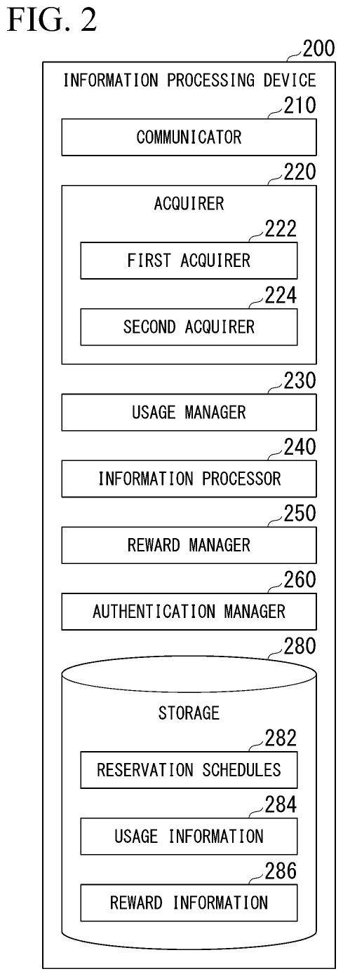

FIG. 2 is a diagram showing an example of a functional configuration of the information processing device 200. The information processing device 200 includes, for example, a communicator 210, an acquirer 220, a usage manager 230, an information processor 240, a reward manager 250, an authentication manager 260, and a storage 280. The acquirer 220, the usage manager 230, the information processor 240, the reward manager 250, and the authentication manager 260 are each realized by a processor such as a CPU executing a program (software) stored in a storage device. Some or all of these functional components may be realized by hardware such as an LSI, an ASIC, or an FPGA or may be realized by hardware and software in cooperation.

The storage 280 includes, for example, reservation schedules 282, usage information 284, and reward information 286. This information will be described later.

The communicator 210 is a communication interface for communicating with other devices via the network NW. The communicator 210 acquires, for example, information transmitted by the terminal devices 100 and information transmitted by the charging facilities 300. The communicator 310 may acquire the states of charge of the batteries of vehicles M, the positions of the vehicles M, and the like.

The acquirer 220 includes, for example, a first acquirer 222 and a second acquirer 224. The first acquirer 222 acquires a usage request from a terminal device 100 of a user. The usage request is a request regarding use of a charging facility 300 for charging a battery B mounted in a vehicle M. The second acquirer 224 acquires permission information. The permission information is information indicating permission of the usage request. The permission is being given by a user who is authorized to use the charging facility 300 in a time zone associated with (corresponding to) a desired time zone included in the usage request. The permission is to grant a request included in the usage request.

The usage manager 230 manages reservation requests, for example, on the basis of the reservation requests and the reservation schedules 282. A reservation request is information including identification information of a user (a user ID), a charging facility 300 designated by the user (a charging facility 300 that the user desires to use), the usage time of the charging facility 300, and the like.

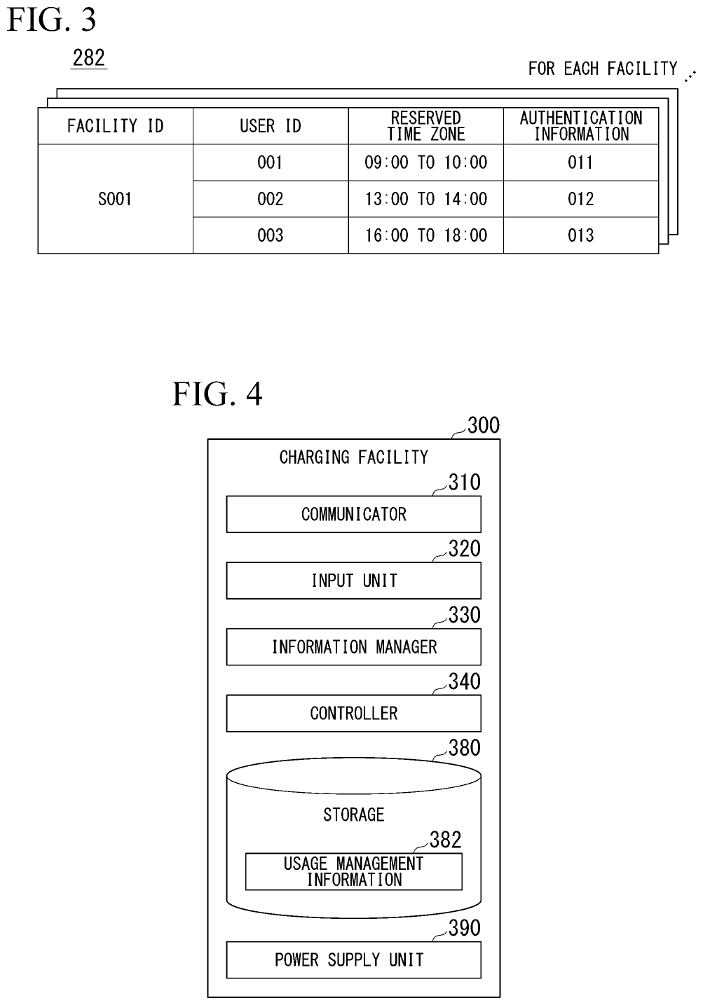

FIG. 3 is a diagram showing an example of content of a reservation schedule 282. The reservation schedule 282 is information in which a charging facility 300 is associated with a user ID indicating one who reserves, a reserved time zone, and authentication information. The authentication information is information for authenticating a user who uses the charging facility 300 (details will be described later).

The information processor 240 manages schedules regarding the usage of charging facilities 300 on the basis of usage requests, permission information, and the like. The information processor 240 manages, for example, the reservation schedules 282.

The reward manager 250 gives the user a reward for the permission on the basis of the usage request acquired by the first acquirer 222 and the permission information acquired by the second acquirer 224. The reward is money, a discount, a coupon, or the like.

The authentication manager 260 determines whether or not information transmitted by the charging facility 300 (input information) and authentication information in the reservation schedule 282 match in response to an authentication request transmitted by the charging facility 300. This authentication information is authentication information that is associated with a reserved time associated with the current time. The authentication manager 260 transmits the determination result to the charging facility 300. Upon receiving the usage request, the information processing device 200 provides the authentication information to the terminal device 100 of the user.

[Charging Facility]

FIG. 4 is a diagram showing an example of a functional configuration of each charging facility 300. The charging facility 300 includes, for example, a communicator 310, an input unit (an input device) 320, an information manager 330, a controller 340, a storage 380, and a power supply unit (a power supply device) 390. The information manager 330 and the controller 340 are each realized, for example, by a processor such as a CPU executing a program (software) stored in a storage device. Some or all of these functional components may be realized by hardware such as an LSI, an ASIC, or an

FPGA or may be realized by hardware and software in cooperation. The storage 380 stores usage management information 382. The usage management information 382 is, for example, information such as a time during which a user has used a charging facility 300 and the amount of power supplied to a vehicle M of the user. For example, the usage management information 382 is transmitted to the information processing device 200 and stored in the storage 280 as usage information 284. The information processing device 200 derives the usage fee of the charging facility 300 on the basis of the usage management information 382.

The communicator 310 is a communication interface for communicating with other devices via the network NW. The communicator 310 transmits, for example, the usage status of the charging facility 300 and the usage management information 382 to the information processing device 200. The communicator 310 acquires information transmitted by the information processing device 200.

The input unit 320 includes operation buttons through which the user U inputs predetermined information. For example, the user U inputs a set number or the like through the input unit 320.

The information manager 330 transmits the input information input through the input unit 320 to the information processing device 200 and issues an authentication request to the information processing device 200. The information manager 330 acquires a determination result for the authentication request transmitted by the information processing device 200. The determination result indicates that the input information matches (authentication is successful) the authentication information or the input information does not match (authentication is unsuccessful) the authentication information.

The controller 340 permits the user to use the power supply unit 390 when the authentication is successful. For example, when the authentication is successful and a connection portion provided in the power supply unit 390 is connected to a connection portion of the vehicle M, the controller 340 causes the power supply unit 390 to supply power to the vehicle M.

### [Sequence]

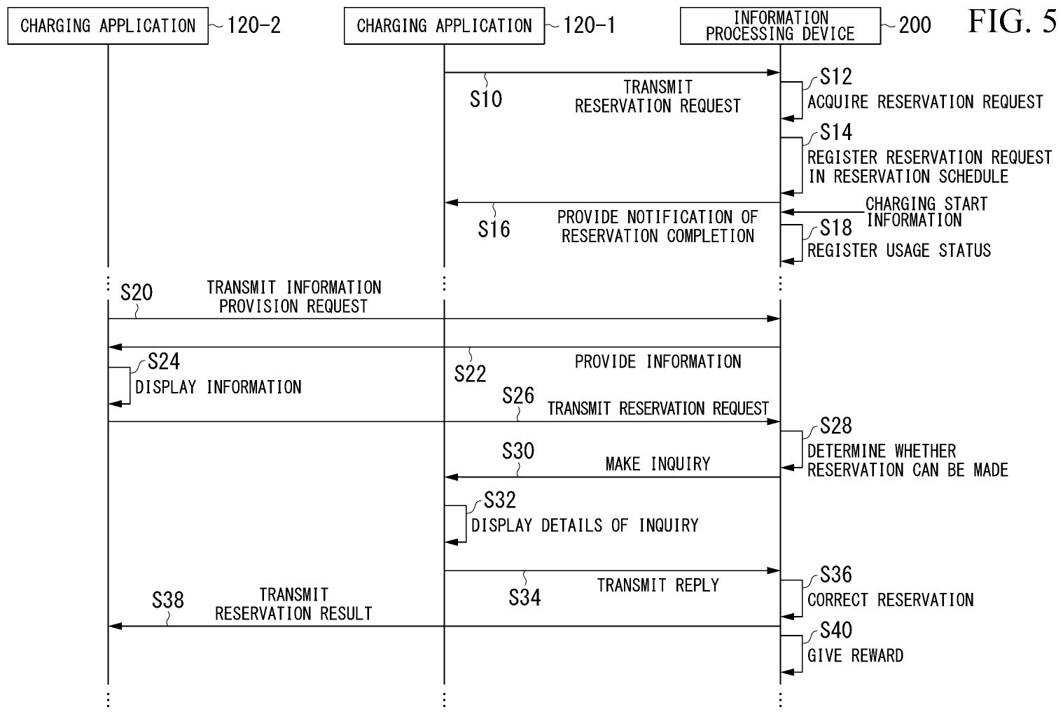

FIG. 5 is a sequence diagram showing an example of a flow of processing executed by charging applications 120 and the information processing device 200. First, a charging application 120-1 transmits a reservation request to the information processing device 200 according to an operation performed by its user (step S10). Next, the first acquirer 222 acquires the reservation request (step S12). Next, the usage manager 230 registers the acquired reservation request in a reservation schedule 282 (step S14). Next, the usage manager 230 transmits a notification of reservation completion, which indicates that the reservation request has been registered in the reservation schedule 282, to the charging application 120-1 (step S16).

Next, upon acquiring start information indicating start of charging from a charging facility 300, the information processor 240 registers information indicating that charging has started in the usage information 284 (step S18). The start information is information indicating that charging has been started by the user who can use the charging facility 300 registered in the reservation schedule 282.

In this way, the user can reserve use of the charging facility 300 or perform charging based on the reservation using the charging application 120-1.

Next, a charging application 120-2 transmits an information provision request to the information processing device 200 (step S20). Next, the information processor 240 transmits information according to the information provision request transmitted to the information processing device 200 to the charging application 120-2 (step S22).

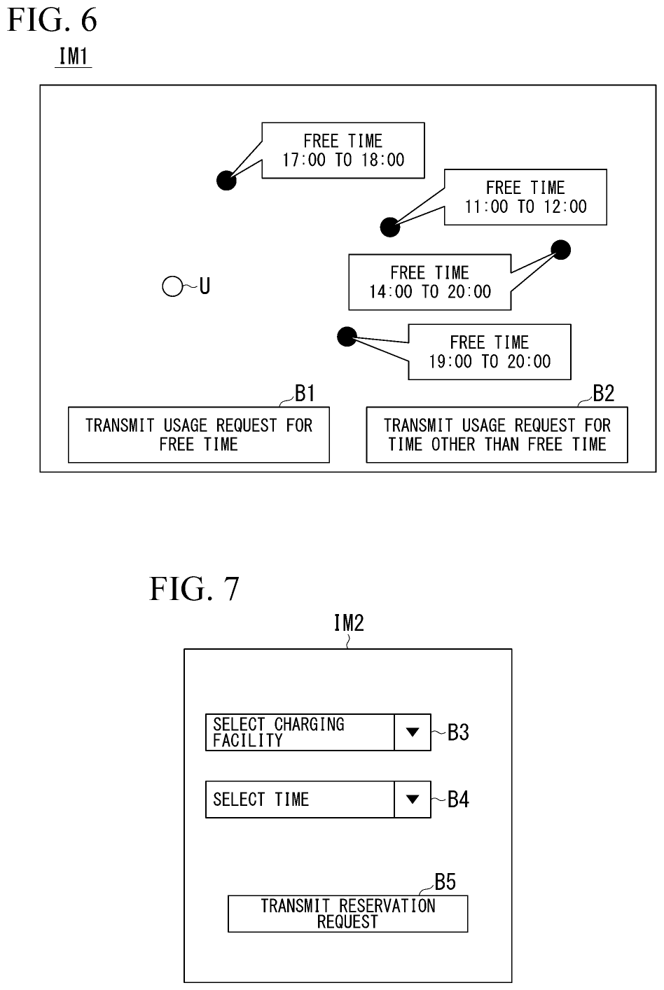

Next, the charging application 120-2 causes a display of a terminal device 100-2 to display the information transmitted by the information processing device 200 (see an image IM1 of FIG. 6 which will be described later) (step S24). Next, the charging application 120-2 transmits a reservation request according to an operation performed by its user (step S26).

FIG. 6 is a diagram showing an example of the image IM1 displayed on the display. For example, the image IM1 includes information indicating the position of the user and the positions of charging facilities 300 and information indicating the availability of each charging facility 300 when the charging facility 300 is available (or a time during which the charging facility 300 is not available). The image IM1 includes a button B1 and a button B2. The button B1 is for transmitting a usage request for an available charging facility 300. The button B2 is a button for transmitting a usage request for a time other than an available time of the charging facility 300. For example, when the user has operated the button B2, the charging application 120-2 causes the display of the terminal device 100-2 to display an image IM2. Hereinafter, the user who has transmitted the usage request for a time other than an available time of the charging facility 300 may be referred to as a “first user.”

FIG. 7 is a diagram showing an example of the image IM2. The image IM2 includes a button B3, a button B4, and a button B5. The button B3 is, for example, a button for selecting a charging facility 300. The button B4 is, for example, a button for selecting a time during which the charging facility 300 is to be used. The button B5 is, for example, a button for transmitting a reservation request including the selection results of the button B3 and the button B4 to the information processing device 200. For example, the charging application 120-2 transmits a usage request to the information processing device 200 when the first user has operated the button B5 after operating the buttons 3 and 4.

Next, the information processor 240 refers to the reservation schedule 282 to determine whether or not a reservation can be made for the time in the reservation request transmitted in step S26 (step S28). Here, it is assumed that it is determined that a reservation cannot be made for the time designated in the reservation request transmitted in step S26. That is, it is assumed that a reservation has already been made by another user (hereinafter referred to as a “second user”).

Next, the information processor 240 makes an inquiry to the second user who has already made a reservation before the first user transmits the reservation request (step S30). This inquiry is as to whether to allow the use of the first user to be prioritized over the use of the second user as shown in an image IM3. The charging application 120-1 causes the display to display details of the inquiry transmitted in step S30 (step S32).

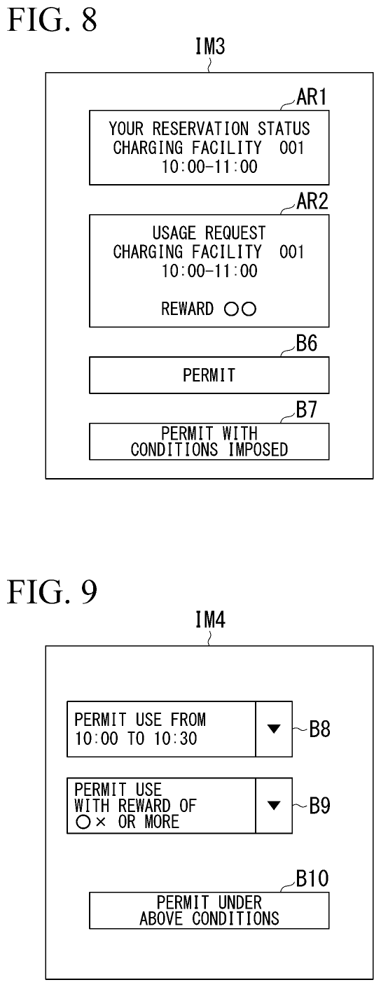

FIG. 8 is a diagram showing an example of the image IM3. The image IM3 includes an area AR1, an area AR2, a button B6, and a button B7. The area AR1 is an area including information indicating details of the reservation of the second user (a reserved time and a reserved charging facility). The area AR2 is information indicating details of the usage request of the first user. The information indicating the usage request includes information indicating the charging facility that the user desires to use, a time zone during which the user desires to use it, information indicating a reward given to the second user when the second user permits the use of the first user, and the like.

The button B6 is, for example, a button for permitting the use of the first user. The button B7 is, for example, a button for permitting the use of the first user with conditions imposed on the use of the first user. For example, when the second user has operated the button B6, the charging application 120-1 transmits a reply indicating permission of the use to the information processing device 200. For example, when the second user has operated the button B7, the charging application 120-1 causes the display of the terminal device 100-1 to display an image IM4.

FIG. 9 is a diagram showing an example of content of the image IM4. The image IM4 includes a button B8, a button B9, and a button B10. The buttons B8 and B9 are buttons through which the second user imposes conditions on the permission of use. The conditions are one or both of a usage time of the charging facility 300 and a reward. The button B8 is, for example, a button through which the second user designates the usage time of the charging facility 300. For example, when the second user permits the first user to use the charging facility 300 for only a part of the reserved time, the second user operates the button B8 to designate the time during which the use is permitted. The button B9 is, for example, a button through which the second user designates a reward for the permission of the use of the charging facility 300. For example, when the second user has operated the button B10 after operating the buttons B8 and B9 to designate the conditions regarding the permission of use, the charging application 120-1 transmits information indicating the designated conditions to the information processing device 200 as a reply.

Next, the charging application 120-1 transmits a reply to the inquiry transmitted in step S30 to the information processing device 200 (step S34). For example, it is assumed that the second user has permitted the use of the first user. Next, the information processor 240 corrects the reservation schedule 282 on the basis of the result of the reply transmitted in step S34 (step S36). For example, the information processor 240 cancels the reservation of the second user and registers the reservation of the first user in the reservation schedule 282.

Next, the information processor 240 transmits the corrected reservation result to the charging application 120-2 (step S38). When the second user has designated conditions to permit the use, the designated conditions are transmitted to the terminal device 100-2 of the first user. When the first user has accepted the designated conditions, the first user can use the charging facility 300 on the basis of the accepted conditions.

Next, the reward manager 250 gives a reward to the second user (step S40). The reward manager 250 associates the reward paid to the second user with reward information 286. That is, the reward manager 250 acquires the reward from the first user and gives the acquired reward to the second user. The reward manager 250 sets the reward acquired from the first user and the reward given to the second user to be equivalent. Equivalence means that the values of rewards are substantially the same.

The reward manager 250 may determine the reward to be given to the second user on the basis of the conditions for permission regarding the use of the charging facility 300 which have been designated by the second user or on the basis of the length of the time zone during which the first user desires to use the charging facility defined in the usage request. For example, the reward may be a reward designated by the second user or a reward based on the time during which the first user desires to use the charging facility 300 defined in the usage request. For example, the longer the time during which the first user desires to use the charging facility 300, the greater the reward.

When the frequency of use of the charging facility 300 by the second user is high, the reward may be higher than when the frequency is low. This is because the second user permits the first user to use the charging facility 300 despite the high frequency of use of the charging facility 300. The reward may be determined based on the state of the vehicle M of the first user or the second user. For example, when the charged amount of the vehicle M of the first user is high, the reward may be higher than when the charged amount is low. This is because the need to charge the vehicle M of the first user is low. For example, when the charged amount of the vehicle M of the second user is low, the reward may be higher than when the charged amount is high. This is because the need to charge the vehicle M of the second user is high.

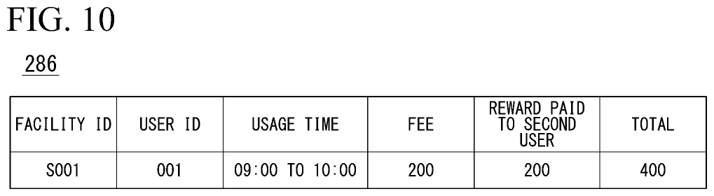

FIG. 10 is a diagram showing an example of content of the reward information 286. The reward information 286 is, for example, information in which a facility ID, a user ID, a usage time during which the first user desires to use the charging facility 300, a fee according to the usage time, a reward paid to the second user, and a total fee are associated with each other. The total fee is the sum of the fee according to the usage time and the reward paid to the second user.

As described above, the information processing device 200 asks the second user who is scheduled to use the charging facility 300 for permission to use the charging facility 300 and permits the first user to use the charging facility 300 upon obtaining the permission, whereby it is possible to encourage flexible use of the charging facility.

According to the first embodiment described above, the information processing device 200 gives the second user a reward for permission of the use of the charging facility 300 on the basis of both the usage request regarding use of the charging facility 300 for charging the battery B mounted in the vehicle M of the first user, which is received from the terminal device 100-2 of the first user, and permission information indicating permission of the usage request from the terminal device 100-1 of the second user who is authorized to use the charging facility 300 in a time zone associated with a desired time zone included in the usage request, whereby it is possible to encourage flexible use of the charging facility.

### Second Embodiment

A second embodiment will be described below. An information processing device 200A of the second embodiment provides the second user with information regarding another charging facility 300 that he or she can use. Differences from the first embodiment will be mainly described below.

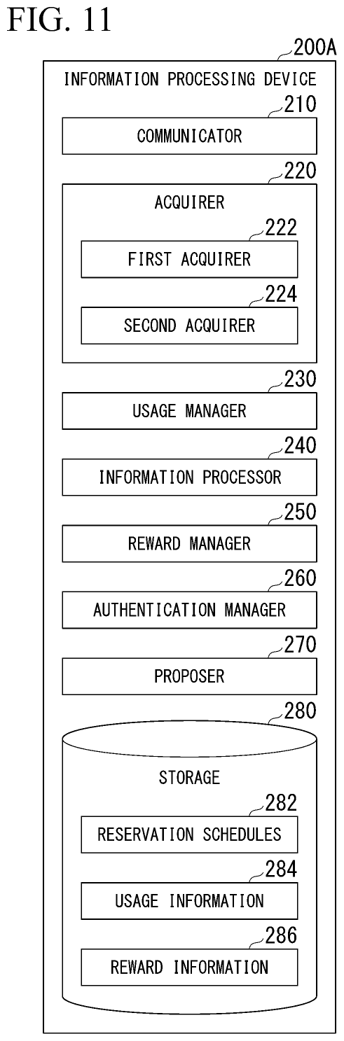

FIG. 11 is a diagram showing an example of a functional configuration of the information processing device 200A. The information processing device 200A further includes, for example, a proposer 270 in addition to the functional components of the information processing device 200 of the first embodiment.

The proposer 270 refers to the reservation schedules 282 and map information (not shown) stored in the storage 280 to propose another charging facility 300 that the second user can use when he or she has permitted the first user to use the charging facility 300. For example, the proposer 270 identifies a charging facility 300 which the second user can move to within a predetermined time from the current location of the second user or which is present within a predetermined distance from the current position and which the second user can use at the time of arrival at the charging facility 300 (at the time estimated to arrive at the charging facility 300). Then, the proposer 270 proposes the identified charging facility 300 to the second user. The arrival time is the time at which the vehicle M of the second user is estimated to arrive at the proposed charging facility 300 when heading to the proposed charging facility 300 from the current location in the current traffic situation.

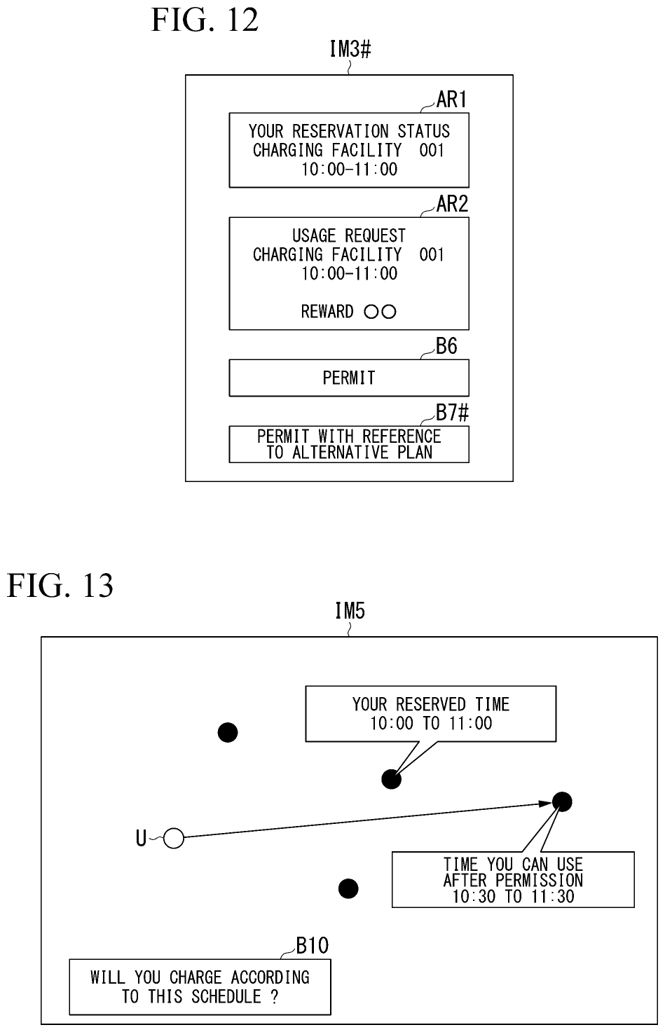

An information processor 240 of the information processing device 200A provides the charging application 120-1 with information for causing the display of the terminal device 100-1 to display an image IM3# instead of the image IM3. The charging application 120-1 causes the display of the terminal device 100-1 to display the image IM3# instead of the image IM3. FIG. 12 is a diagram showing an example of the image IM3#. The image IM3# includes a button B7# instead of the button B7. The button B7# is a button for causing the display to display information on a charging facility 300 that the second user can use (a charging facility 300 different from the reserved charging facility 300), a route from the position of the second user to the charging facility 300, and the like. When the second user has operated the button B7#, the charging application 120-1 causes the display of the terminal device 100-1 to display an image IM5.

FIG. 13 is a diagram showing an example of the image IMS. The image IM5 includes, for example, information on a charging facility 300 that the second user was scheduled to use, information on a charging facility 300 that the second user can use after permitting the first user to use the reserved charging facility 300, and information indicating a route from the position of the second user or the position of the reserved charging facility 300 to the charging facility 300 that the second user can use after the permission.

The image IM5 includes a button B10. The button B10 is, for example, a button for deciding to use the charging facility 300 recommended by the charging application 120-1. Upon acquiring the information indicating that the button B10 has been operated from the charging application 120-1, the information processor 240 reserves the charging facility 300 that the second user can use after the permission.

As described above, the proposer 270 proposes an alternative plan to the second user, thereby encouraging the second user to permit the first user to use the reserved charging facility 300.

According to the second embodiment described above, upon acquiring a usage request from the first user, the information processing device 200 acquires a charging facility 300 to be recommended to the second user on the basis of the usage request and transmits information on the acquired charging facility 300 to the terminal device 100-1 of the second user, whereby it is possible to encourage more flexible use of the charging facility.

### ANOTHER EXAMPLE (1)

In the embodiment described above, the second user has been described as permitting the first user to use a charging facility 300 in the future. However, instead of (or in addition to) this, the second user may, in real time, permit the first user to use a charging facility 300.

For example, the information processing device 200 may, in real time, ask a second user of a vehicle M, which is being charged by a charging facility 300, for permission to use the charging facility 300 and, upon obtaining the permission, move the vehicle M of the second user to another charging facility 300 or temporarily move the vehicle M of the second user to a standby space.

### ANOTHER EXAMPLE (2)

The information processing device 200 may present predetermined users with a condition for permission regarding the use of the charging facility 300 set by the second user and allow a user who desires to use the charging facility 300 to use the charging facility 300. In this case, using the condition for permission set by the second user as a reference condition, the information processing device 200 may permit a user who has presented a condition better than conditions presented by the other users (for example, a reward greater than rewards presented by the other users) and better than the reference condition to use the charging facility 300. For example, the information processing device 200 may perform an auction regarding the use of the charging facility 300 to determine a user who is permitted to use the charging facility 300.

The reference condition described above may be set by the second user. In this case, the information processing device 200 may permit one of a plurality of first users who has presented the best condition among conditions presented by the plurality of first users that are better than the reference condition set by the second user to use the charging facility 300.

The above embodiments may be implemented in combination.

### [Hardware Configuration]

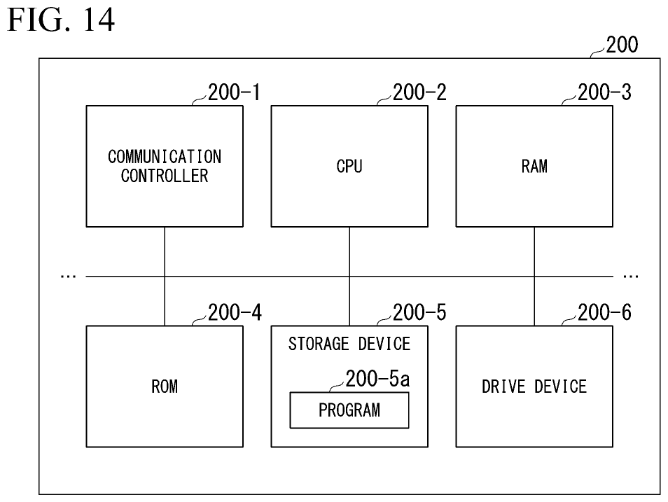

FIG. 14 is a diagram showing an example of a hardware configuration of an information processing device 200 according to an embodiment. As shown, the information processing device 200 is configured such that a communication controller 200-1, a CPU 200-2, a random access memory (RAM) 200-3 used as a working memory, a read only memory (ROM) 200-4 storing a boot program or the like, a storage device 200-5 such as a flash memory or a hard disk drive (HDD), a drive device 200-6, or the like are connected to each other via an internal bus or a dedicated communication line. The communication controller 200-1 performs communication with components other than the information processing device 200. The storage device 200-5 stores a program 200-5a to be executed by the CPU 200-2. This program is loaded into the RAM 200-3 by a direct memory access (DMA) controller (not shown) or the like and then executed by the CPU 200-2. Thereby, some or all of the acquirer 220, the usage manager 230, the information processor 240, the reward manager 250, and the authentication manager 260 are realized.

The embodiments described above can be expressed as follows.

A vehicle control device including:

a storage device configured to store a program; and

a hardware processor,

wherein the hardware processor is configured to execute the program stored in the storage device to:

acquire a usage request regarding use of a charging facility for charging a battery mounted in a vehicle from a terminal device of a first user;

acquire permission information indicating permission of the usage request from a terminal device of a second user who is authorized to use the charging facility in a time zone associated with a desired time zone included in the usage request; and

give the second user a reward for the permission on the basis of the usage request and the permission information.

Although modes for carrying out the present invention have been described above by way of embodiments, the present invention is not limited to these embodiments at all and various modifications and substitutions can be made without departing from the gist of the present invention.

What is claimed is:

1. An information processing device comprising:
a first acquirer configured to acquire a usage request regarding use of a charging facility for charging a battery mounted in a vehicle from a terminal device of a first user;
a second acquirer configured to acquire permission information indicating permission of the usage request from a terminal device of a second user who is authorized to use the charging facility in a time zone associated with a desired time zone included in the usage request; and
a processor configured to give the second user a reward for the permission on the basis of the usage request acquired by the first acquirer and the permission information acquired by the second acquirer.

2. The information processing device according to claim 1, wherein the processor is configured to acquire a reward from the first user and give the acquired reward to the second user.

3. The information processing device according to claim 2, wherein the processor is configured to set the reward acquired from the first user and the reward given to the second user to be equivalent.

4. The information processing device according to claim 1, wherein the processor is configured to determine a reward to be given to the second user on the basis of a length of a time zone during which the first user desires to use the charging facility defined in the usage request.

5. The information processing device according to claim 1, wherein the permission information includes a condition for the permission, and
the processor is configured to give a reward to the second user on the basis of the condition for the permission.

6. The information processing device according to claim 5, wherein the condition for the permission is one or both of the usage time of the charging facility and the reward.

7. The information processing device according to claim 1, further comprising a proposer configured to, when the first acquirer has acquired the usage request, acquire a charging facility to be recommended to the second user on the basis of the usage request and transmit information on the acquired charging facility to the terminal device of the second user.

8. The information processing device according to claim 7, wherein the charging facility to be recommended to the second user is a charging facility which the second user is able to move to within a predetermined time from a current location of the second user or which is present within a predetermined distance from the current location and which the second user is able to use after arriving at the charging facility.

9. An information processing method causing a computer perform:
acquiring a usage request regarding use of a charging facility for charging a battery mounted in a vehicle from a terminal device of a first user;
acquiring permission information indicating permission of the usage request from a terminal device of a second user who is authorized to use the charging facility in a time zone associated with a desired time zone included in the usage request; and
giving the second user a reward for the permission on the basis of the usage request and the permission information.

10. A non-transitory computer-readable storage medium that is configured to store a computer program to be executed by a computer to perform at least:
acquire a usage request regarding use of a charging facility for charging a battery mounted in a vehicle from a terminal device of a first user;
acquire permission information indicating permission of the usage request from a terminal device of a second user who is authorized to use the charging facility in a time zone associated with a desired time zone included in the usage request; and
give the second user a reward for the permission on the basis of the usage request and the permission information.
